(19) United States
(12) Patent Application Publication
(10) Pub. No.: US 2026/0320698 A1
(43) Pub. Date: Oct. 15, 2026

(54) Artificial Intelligence Health Insurance Enrollment

(71) Applicant: Oracle International Corporation, Redwood Shores, CA (US)

(72) Inventors: Zachary S. ANKROM, Austin, TX (US); Melissa WOO, Chicago, IL (US); Courtney DMOCHOWSKI, Nashville, TN (US); Daniel RITTER, Prairie Village, KS (US); Nahush PATEL, Alpharetta, GA (US); Connie Ann SCHMIDT, Berwyn, PA (US)

(21) Appl. No.: 19/395,430

(22) Filed: Nov. 20, 2025

Related U.S. Application Data
(60) Provisional application No. 63/786,427, filed on Apr. 10, 2025.

(51) Int. Cl. G06Q 40/08

(52) U.S. Cl. CPC G06Q 40/082; G06Q 40/09

(57) ABSTRACT

Embodiments provide cloud based health insurance enrollment for a user. Embodiments determine that open health insurance enrollment is available for the user and, using a pre-trained large language learning machine learning (“ML”) model, automatically presents to the user a plurality of available health insurance options based on a current health insurance or qualifications for insurance. Embodiments, using the ML model, automatically analyze the available health insurance options and, using a generative artificial intelligence (“AI”) model, automatically answer questions from the user regarding the available health insurance options.

### CROSS REFERENCE TO RELATED APPLICATIONS

This application claims priority to U.S. Provisional Patent Application Ser. No. 63/786,427 filed on Apr. 10, 2025, the disclosure of which is hereby incorporated by reference.

### FIELD

One embodiment is directed generally to a computer system, and in particular to a computer system for health insurance enrollment.

### BACKGROUND INFORMATION

In certain jurisdictions, such as the United States, health insurance enrollment is a complex and time-consuming process, often requiring individuals to select or update their coverage annually across various health and pharmacy benefit insurance models, including commercial providers (e.g., UnitedHealthcare, Aetna, Cigna) and government-sponsored programs (e.g., Medicare, Medicaid, Health Exchange, CHIP) and pharmacy benefit coverage via, for example, through pharmacy benefit managers. Each insurer has distinct enrollment requirements, and enrollees must navigate plan variations in coverage, cost, and eligibility.

For many consumers, completing enrollment forms can be tedious and overwhelming, especially for first-time enrollees or those whose personal information is not prefilled. The lack of integrated data across systems results in inefficiencies, redundant manual entry, and increased risk of errors. As a result, individuals may experience frustration, delays in coverage, or even missed enrollment windows, leading to gaps in critical healthcare access.

### SUMMARY

Embodiments provide cloud based health insurance enrollment for a user. Embodiments determine that open health insurance enrollment is available for the user and, using a pre-trained large language learning machine learning (“ML”) model, automatically presents to the user a plurality of available health insurance options based on a current health insurance or qualifications for insurance. Embodiments, using the ML model, automatically analyze the available health insurance options and, using a generative artificial intelligence (“AI”) model, automatically answer questions from the user regarding the available health insurance options.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Further, elements may not be drawn to scale.

FIG. 1 illustrates an example of a system that includes a health insurance enrollment system in accordance to embodiments.

FIG. 2 is a block diagram of the health insurance enrollment system of FIG. 1 in the form of a computer server/system in accordance to an embodiment of the present invention.

FIG. 3 is a flow/block diagram of the functionality of the health insurance enrollment system of FIG. 1 and associated elements when providing health insurance enrollment in accordance with one embodiment.

FIGS. 4-7 illustrate an example cloud infrastructure can include the health insurance enrollment system of FIG. 1 in accordance to embodiments.

### DETAILED DESCRIPTION

Embodiments implement Artificial Intelligence (“AI”)/Machine Learning (“ML”) to support a patient or consumer user (i.e., an individual who can act on behalf of the patient and is either the patient's legal authorized representative, health guardian, or health partner) to complete enrollment for health insurance more efficiently and expeditiously. Embodiments provide automated prompts to remind the patient that open enrollment is available, provide a summarization of information for the benefits, and enable the patient to use pre-filled information taken from their patient portal profile or a pre-visit registration to complete the enrollment.

Embodiments provide the consumer with an AI-powered assistant designed to streamline and simplify the health insurance enrollment process by: (1) Proactively notifying consumers about their eligibility for open enrollment; (2) Assisting with plan renewal by presenting details of the consumer's current plan, highlighting any changes, and enabling easy confirmation if the consumer wishes to keep their existing coverage; (3) Leveraging pre-existing consumer data (e.g., demographics, contact information, guarantor, beneficiaries, etc.) to pre-fill enrollment forms, reducing manual effort and minimizing entry errors; (4) Helping consumers compare insurance plans by analyzing coverage, costs, deductibles, and out-of-pocket expenses across multiple plan options to support informed decision-making; and (5) Facilitating seamless submission of enrollment details of the selected insurance plan(s) and automatically updating insurance coverage information as appropriate to connected systems.

Embodiments implement a specialized large language model (“LLM”) trained for health insurance enrollment. When open enrollment begins, whether through an employer-sponsored plan or through open enrollment in a marketplace, users can seamlessly interact with a website, mobile app, form, chatbot, or virtual assistant to complete their enrollment.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

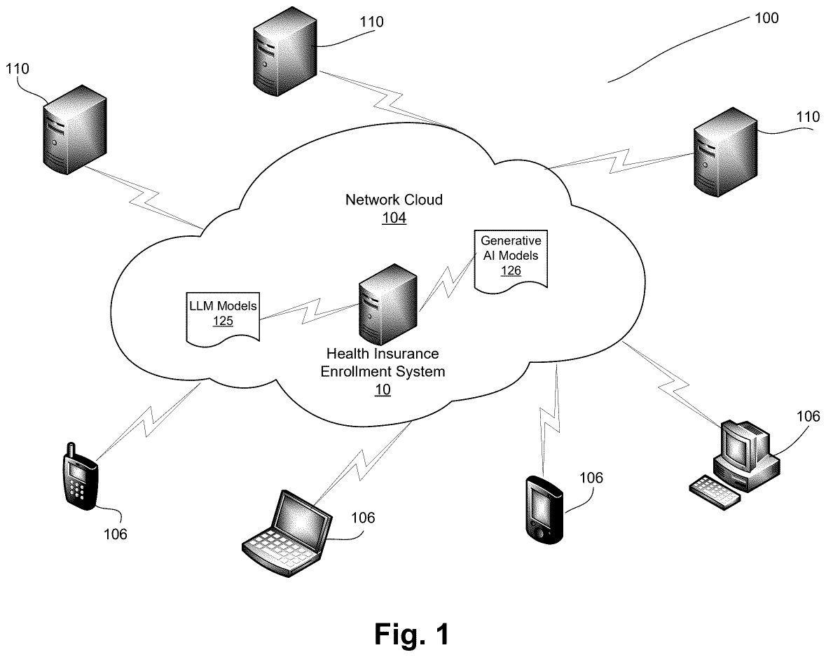

FIG. 1 illustrates an example of a system 100 that includes a health insurance enrollment system 10 in accordance to embodiments. Health insurance enrollment system 10 may be implemented within a computing environment that includes a communication network/cloud 104. Network 104 may be a private network that can communicate with a public network (e.g., the Internet) to access additional services 110 provided by a cloud services provider. Examples of communication networks include a mobile network, a wireless network, a cellular network, a local area network (“LAN”), a wide area network (“WAN”), other wireless communication networks, or combinations of these and other networks. Health insurance enrollment system 10 may be administered by a service provider, such as via the Oracle Cloud Infrastructure (“OCI”) from Oracle Corp.

Tenants of the cloud services provider can be companies or any type of organization or groups whose members include users of services offered by the service provider. Services may include or be provided as access to, without limitation, an application, a resource, a file, a document, data, media, or combinations thereof. Users may have individual accounts with the service provider and organizations may have enterprise accounts with the service provider, where an enterprise account encompasses or aggregates a number of individual user accounts.

System 100 further includes client devices 106, which can be any type of device that can access network 104 and can obtain the benefits of the functionality of aspect based sentiment analysis system 10 for analyzing performance reviews. As disclosed herein, a “client” (also disclosed as a “client system” or a “client device”) may be a device or an application executing on a device. System 100 includes a number of different types of client devices 106 that each is able to communicate with network 104.

Executing on cloud 104 (or otherwise in communication with aspect based sentiment analysis system 10) is at least one large language model (“LLM”) 125. An LLM is a type of artificial intelligence (“AI”) model that is trained on a large amount of text data. An LLM can generate text, translate text from one language to another, write different kinds of creative content, and answer questions in an informative way. In general, an LLM is a machine that has been taught to understand and use language the way that humans do. An LLM can read and write, and can understand and respond to complex questions. Examples of LLMs that can be used in embodiments include “ChatGPT”, “Bard AI”, and various open source LLMs. Embodiments can be implemented with any sufficiently large LLM. However, LLMs trained with domain specific data can provide more accurate results.

LLM 125 is leveraged to process and generate content to be presented to the user including the processing and interpretation of user questions and prompts through a website, form, chatbot, or virtual assistant to generate text and tasks. LLM 125 can leverage a transformer model (i.e., neural network) to interpret the human language and complex data to gather information and present back curated data/information for the user in a fine-tuned or prompt-tuned to the specific task (e.g., gathering insurance and enrollment information for the user).

LLM 125 can perform tasks and retrieve data based on the user's prompts and inquires for information related to this invention. LLM 125 can either be pre-trained by a particular organization (e.g., healthcare provider, health insurance company, or other related agency), use transformer language models to use code generation/translation, or leverage natural language processing. LLM 125 can process and understand a user's prompts based on their inquiry to discover health insurance options or determine when health insurance enrollment is available. LLM 125 can present available health insurance options that are available to the patient based on their current health insurance or qualifications for insurance. LLM 125 can analyze available health insurance options that helps drive the consumer to a decision point. LLM 125 can summarize the health insurance plan that the patient/consumer has selected.

In addition to LLM 125, system 100 may further include and use one or more generative AI (“GenAI”) models 126. Through GenAI foundation models, AI model 126 can recognize user questions and prompts to generate health insurance enrollment information based on available information the GenAI service has available to surface health insurance information available to the foundation model. Based on care that an insurance subscriber has received in the past and based on the question/prompts supplied within a chatbot or digital assistant, models 126 (i.e., deep learning models) can generate health insurance options that the user has available to them and cost differences and health insurance plan differences.

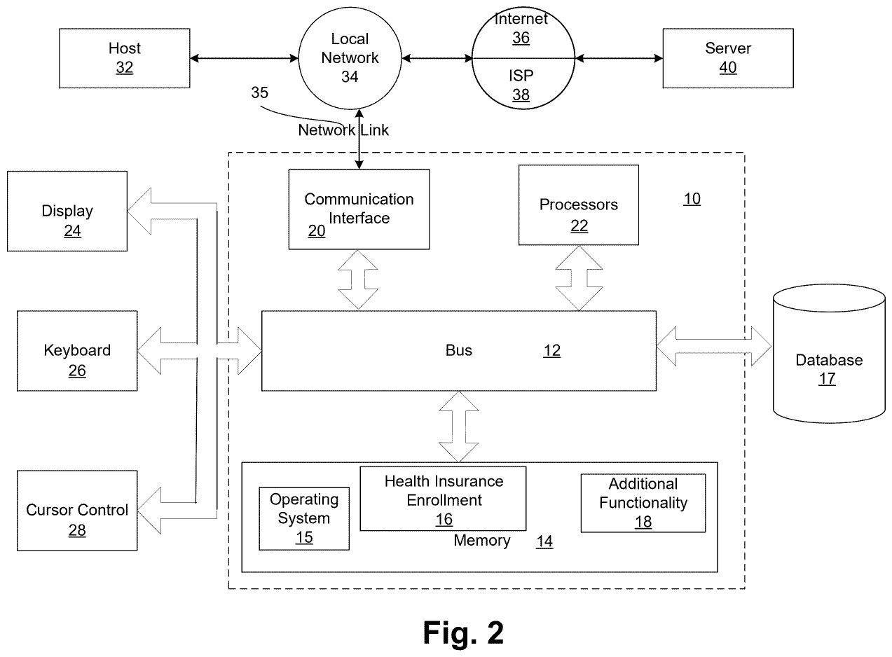

FIG. 2 is a block diagram of health insurance enrollment system 10 of FIG. 1 in the form of a computer server/system 10 in accordance to an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. One or more components of FIG. 2 can also be used to implement any of the elements of FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication interface 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an health insurance enrollment module 16 that provides AI based health insurance enrollment, and all other functionality disclosed herein. System 10 can be part of a larger system. Therefore, system 10 can include one or more additional functional modules 18, such as the “Oracle Health Patient Portal” or the “Oracle Health Patient Administration” from Oracle Corp., that utilizes the health insurance enrollment module functionality. A file storage device or database 17 is coupled to bus 12 to provide centralized storage for modules 16 and 18, including training data used to generate the ML models. In one embodiment, database 17 is a relational database management system (“RDBMS”) that can use Structured Query Language (“SQL”) to manage the stored data.

In embodiments, communication interface 20 provides a two-way data communication coupling to a network link 35 that is connected to a local network 34. For example, communication interface 20 may be an integrated services digital network (“ISDN”) card, cable modem, satellite modem, or a modem to provide a data communication connection to a corresponding type of telephone line or Ethernet. As another example, communication interface 20 may be a local area network (“LAN”) card to provide a data communication connection to a compatible LAN. Wireless links may also be implemented. In any such implementation, communication interface 20 sends and receives electrical, electromagnetic or optical signals that carry digital data streams representing various types of information.

Network link 35 typically provides data communication through one or more networks to other data devices. For example, network link 35 may provide a connection through local network 34 to a host computer 32 or to data equipment operated by an Internet Service Provider (“ISP”) 38. ISP 38 in turn provides data communication services through the Internet 36. Local network 34 and Internet 36 both use electrical, electromagnetic or optical signals that carry digital data streams. The signals through the various networks and the signals on network link 35 and through communication interface 20, which carry the digital data to and from computer system 10, are example forms of transmission media.

System 10 can send messages and receive data, including program code, through the network(s), network link 35 and communication interface 20. In the Internet example, a server 40 might transmit a requested code for an application program through Internet 36, ISP 38, local network 34 and communication interface 20. The received code may be executed by processor 22 as it is received, and/or stored in database 17, or other non-volatile storage for later execution.

In one embodiment, system 10 is a computing/data processing system including an application or collection of distributed applications for enterprise organizations, and may also implement logistics, manufacturing, and inventory management functionality. The applications and computing system 10 may be configured to operate locally or be implemented as a cloud-based networking system, for example in an infrastructure-as-a-service (“IAAS”), platform-as-a-service (“PAAS”), software-as-a-service (“SAAS”) architecture, or other type of computing solution.

As disclosed, embodiments implement AI to support a patient or consumer user to complete enrollment for health insurance more efficiently and expeditiously. Embodiments can implement one or more of the following functionality:
Notification of when or whether insurance enrollment is available.
Presentation of available insurance with related information such as the name of plan, type of plan, cost of plan, deductible, maximum out of current health insurance plan data pocket (“MOOP”), plan coverage including what care and procedures are covered, copay details, coinsurance details, for both the current coverage period and the upcoming coverage period being evaluated.
Presentation of the insurance the subscriber qualifies for based on their current information and location, and other health insurance plans specific to a state and particular insurance type they are looking for.
Presentation of health savings account information based on the selected plan and what the benefits offer.
Forecasting out of pocket estimates based on the medical subscriber/user's utilization data based on a particular plan the patient/user is viewing.
Scenario comparison for family coverage spread across single or multiple plans.
Identification by embodiments of the medications and recent visits the insurance subscriber and their dependents have had in order to produce a view of the cost estimates of the medications and visits based on the different health insurance plans the insurance subscriber/user is viewing and comparing.
Identification by embodiments of the care team members (e.g., doctors and clinicians) the insurance subscriber and their dependents have seen in order to do a check if the care team members are in-network based on the insurance plans that the user is viewing.
Evaluation by embodiments of the insurance subscriber and dependents'previous trends of care utilization and medications to determine over the course of a year when they would meet their deductible.
Checking and verifying if co-insurance is connected to the insurance subscriber and dependent's profiles to evaluate cost of care and medications over the course of a year based on the insurance plans they are evaluating.
Based on a selected plan that requires annual wellness visits to supply health savings account dollars, allowing embodiments to generate a task for the patient within their patient portal to schedule their annual wellness visit appointment.
Based on the selected plan and age of the insurance policy holder and dependents, evaluating gaps in care that the individuals qualify for using embodiments to generate a task within their patient portal to schedule the health visit for that particular event (e.g., the subscriber is 45 years old and embodiments know the patient has not had a colonoscopy so embodiments generate a task based on rules to schedule an appointment with the primary care physician for a visit to then get a referral for the colonoscopy with the gastroenterologist).

Embodiments initiate AI (i.e., the functionality of any combination of LLM models 125 and Generative AI models 126), and generate options for the user using helpful prompts such as:
How are you doing today?
Health insurance enrollment is open. Would you like to enroll?
Health insurance enrollment is open. Would you like to get started?
We see that you have not enrolled for insurance for the upcoming year, would you like to enroll?
Would you like to enroll for health insurance?
You qualify for health insurance. Would you like to enroll?

To initiate the functionality, a user of system 10 has the ability to ask a question or type a keyword such as ‘health insurance’, consumer ‘insurance’, ‘enrollment’, ‘open enrollment’, or other such keywords that have been pre-trained by the administrative user responsible for configuring LLM models 125.

Once the system and artificial intelligence recognizes the pre-training prompts, embodiments will ask the user a variety of different questions or prompts to confirm or collect information from the consumer to identify available insurance plans that they qualify for.

Embodiments will ask the consumer if the system can leverage existing information connected to the associated account. For example, embodiments are connected to or implemented with a patient portal, and the consumer will have a portal account with identity and access management entitlements, a connected patient profile, with demographic and contact information, insurance, guarantor, and emergency contact, and health record information. Based on the first use of system 10, or tied to the terms of use of the application, certain consent can be granted by the user for AI based functionality used through the system, form, chatbot, or digital assistant to leverage the user's information (e.g., demographics) and pre-populate data to expedite workflows or prompts to complete tasks. This consent may be granted in perpetuity or may need to be asked each year.

Based on the AI connection to a particular system, such as a patient portal or electronic health record (“EHR”), embodiments can leverage Fast Healthcare Interoperability Resources (“FHIR”) standards to also retrieve patient/consumer/user data for a semantic representation of the data to populate the prompts or forms to complete health insurance. The semantic data can also create a semantic object model based on FHIR to also provide data descriptors aligned with rich data. FHIR is a standard for exchanging healthcare data, developed by HL7, that enables the quick and efficient exchange of EHR data between different systems.

If a user is already enrolled in a particular health insurance plan based on their employment with a specific company or organization, embodiments are able to retrieve that information and present it to the user. Based on the pre-trained model and information, embodiments are able to recommend the same plan, or similar plans, based on the price or comparison of coverage for the individual or the individuals family (inclusion of dependents). For example, assuming embodiments know what plans are available to an entities employee (e.g., HSA, PPO, etc.), embodiments would have access to visit information for the consumer and its dependents. This information (e.g., # of visits a year) could be used by embodiments to recommend the best/cost effective plan. Similarly, if the user is already enrolled in a health insurance plan NOT with their employer, embodiments are able to retrieve that information and present recommendations of similar plans based on price and coverage.

Embodiments have the ability to explain the plan's benefits to the consumer. For example, embodiments are be able to explain plan limits, deductibles, co-pays, co-insurance, and other such consumer obligations. Further, embodiments have the ability to assist the consumer by answering questions such as:
Which plan has a higher deductible?
Which plan has a higher out of pocket maximum?
Which plan will have me paying more out-of-pocket expenses?
What expenses are not included as out-of-pocket?
When and at what percent does coinsurance begin?
Costs associated with family coverage options using single or multiple plans.

In connection with predicting out-of-pocket expenses, embodiments automatically predict out-of-pocket expenses (for either selected option, or each of: individual, individual+dependent, individual+multiple dependents, individual+spouse/domestic partner, and family), in the following categories, as applicable to the plan:

### Annual Premium

Annual deductible for each member (point prior to cost-share)
Annual deductible for all covered members (point prior to cost-share)
Maximum Out of Pocket Expenses for each member (point at which co-insurance)
Maximum Out of Pocket Expenses for all covered members (point at which co-insurance)
Estimates (based on projected healthcare needs):
   Co-pays
      Primary care
      Specialty care
      Emergency
      Inpatient
      Prescription
   Co-insurance
      Primary care
      Specialty care
      Emergency
      Inpatient
      Prescription

Embodiments can be configured to support notifications reminding the consumer of open enrollment start and end time. Embodiments can be configured to optionally support periodic reminders throughout the open enrollment window. Notifications can include email, push and SMS notifications. The user can adjust settings for notifications and alerts via email, SMS text, or push notification. The alert can also be retained within an alerts section within their patient portal or health account. The user can adjust settings to not be alerted or reminded about health insurance enrollment.

Example notifications and alerts with embodiments include the following:
Enrollment is opening soon, click here to complete your enrollment elections.
Based on a selected plan that requires annual wellness visits to supply health savings account dollars, allow embodiments to generate a task for the patient within their patient portal to schedule their annual wellness visit appointment.
Based on the selected plan and age of the insurance policy holder and dependents, evaluate gaps in care that the individuals qualify for so that embodiments generate a task within their patient portal to schedule the health visit for that particular event (e.g., the subscriber is 45 years old and embodiments know the patient has not had a colonoscopy so embodiments generate a task based on rules to schedule an appointment with the primary care physician for a visit to then get a referral for the colonoscopy with the gastroenterologist).

Embodiments include configurations to support open enrollment notifications (e.g., notification triggers: start of window, end of window, optional reminders throughout window). Embodiments can enable a configuration to integrate a payer organization via HL7 and/or FHIR APIs to provide the health insurance enrollment information from a specific commercial or government payer through a marketplace API.

Embodiments establish Application Programming Interface (“API”) keys and tokens between the system and the owner of the APIs. Various API connectors can be connected into the system to support the AI models and LLMs including APIs for:
Insurance Payer
Insurance Plan
Insurance Plan Pricing
Eligibility Estimate Data
Out of pocket cost estimate
Utilization data.

Eligibility APIs that use the standard X12 EDI 270 eligibility transaction and formats in JavaScript Object Notation (“JSON”) can support requests to support the eligibility qualifications based on the various use cases to determine eligibility based on provider, insurance plan, copays, coinsurances, and deductibles. JSON validators are applied to the set up of the integration with the insurance payer and the system in order to identify errors in the API connectors.

Embodiments support internationalization and localization to ensure that the country the system is being used in is adopted to that countries health insurance model and health insurance enrollment processes. Embodiments support multiple translations to present the information appropriately in the preferred translation that the user reads and speaks. Left-to-right and right-to-left presentation is accommodated based on the preferred language and translation.

Embodiments track selections and automatically update insurance coverage information as appropriate to connected systems.

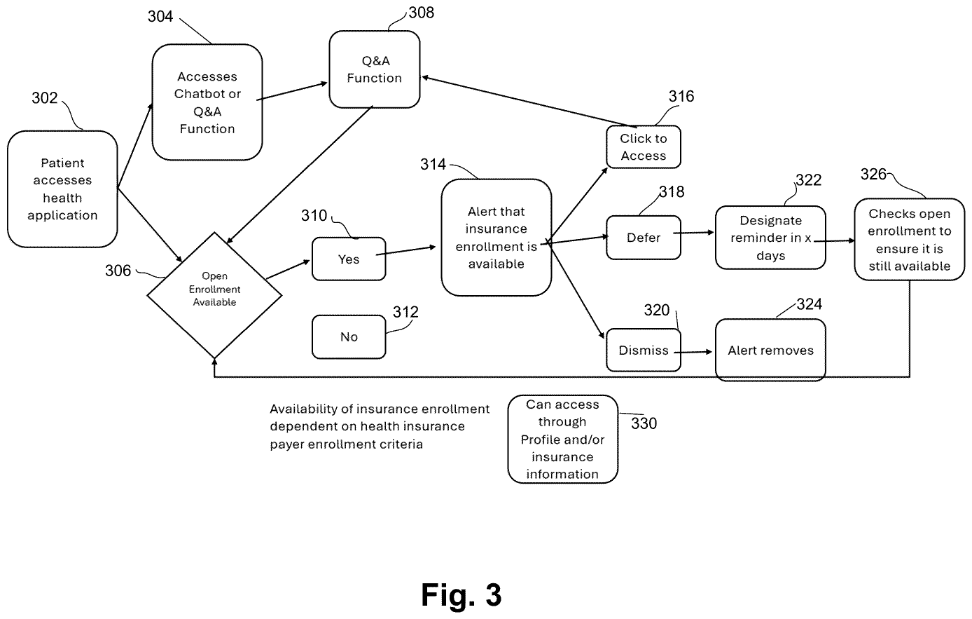

FIG. 3 is a flow/block diagram of the functionality of health insurance enrollment system 10 of FIG. 1 and associated elements when providing health insurance enrollment in accordance with one embodiment. In one embodiment, the functionality of the flow diagram of FIG. 3 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 302, the patient/user accesses the health application, which in embodiments is cloud based and can be accessed from a device 106.

At 304, the user accesses the chatbot (implemented by models 125 and/or 126) or question and answer functions. At 308, the question and answer functions are implemented, providing example questions and answers or prompts as disclosed above. All functionality disclosed herein can be included in the Q&A functionality at 308.

At 306, it is determined if open enrollment for the user's health insurance is available. If no at 306, at 312 functionality ends.

If yes at 306, at 314 an alert is provided to the user that insurance enrollment is available. In response to the alert, the user at 316 can select/click to access the question and answer functionality at 308.

At 318, the user can defer the enrollment decision, and at 322 the user can designate a reminder be provided in a number of days or on a certain date. At 326, on the reminder date, availability of open enrollment is determined, which at 330 can be determined by access to the user profile and/or insurance information. The functionality resumes at 306.

At 320, the alert at 314 can be dismissed, and at 324 the alert is removed.

Embodiments provide several new and unique features tailored to streamline the insurance enrollment process. These features work together to provide a consumer with an intelligent, user-friendly insurance enrollment workflow. Embodiments provide personalized enrollment guidance that uses AI to analyze patient-specific data, offering consumers custom plan recommendations based on healthcare needs and preferences (individual or family). Embodiments provide seamless data integration to pre-fill enrollment forms by leveraging existing patient information, reducing manual input and entry errors. Embodiments provide proactive notifications to leverage integrated consumer notification capabilities, sending intelligent reminders about open enrollment periods and plan changes, ensuring users never miss important deadlines.

Embodiments provide side-by-side comparisons of (including past plans), evaluating coverage, costs, comparative plan analysis of various plans deductibles and out-of-pocket expenses to aid in informed decision-making. Embodiments implement AI to use past clinical, claims, and personal information to create tailored scenarios for a more effective comparison. Comparisons can be generated across vendors or employers for families assessing plans across offerings. These comparisons are smarter, more dynamic, and specific to the user rather than a single employer, for example.

In addition to the ML models disclosed above, embodiments utilize one or more machine learning model(s) to analyze health data, such as data stored via a user's personal health record. A “machine learning model,” as used herein, refers to a construct that is configured (e.g., trained using training data) to make predictions, provide probabilities, augment data, and/or generate data. For example, training data for supervised learning can include items with various parameters and an assigned classification. A new data item can have parameters that a model can use to assign a classification to the new data item. Machine learning models can be configured for various situations, data types, sources, and output formats.

Training data can be any set of data capable of training machine learning model(s), such as a set of features with corresponding labels for supervised learning. Training data can be used to train machine learning model(s) to generate trained machine learning model(s). For example, any suitable training technique (e.g., supervised training via gradient descent, unsupervised training, etc.) can be used to update a configuration of machine learning model(s) (e.g., train the weights of a machine learning model) using training data.

The architecture of implemented machine learning model(s) can include any suitable machine learning model components. For example, a neural network can be implemented along with a given cost function (e.g., for training/gradient calculation). The neural network can include any number of hidden layers (e.g., 0, 1, 2, 3, or many more), and can include feed forward neural networks, recurrent neural networks, convolution neural networks, transformer networks, encoder-decoder architectures, large language model(s), and any other suitable type. In some implementations, the neural network can be configured for deep learning, for example based on the number of hidden layers implemented.

In some implementations, machine learning model(s) can be an ensemble learning model. Multiple models can be stacked, for example with the output of a first model feeding into the input of a second model. Some implementations can include a number of layers of prediction models. In some implementations, features utilized by machine learning model(s) can also be determined, for example via any suitable feature engineering techniques.

In some implementations, the design of machine learning model(s) can be tuned during training, retraining, and/or updated training. For example, tuning can include adjusting a number of hidden layers in a neural network, adjusting a kernel calculation used to implement a support vector machine, and the like. This tuning can also include adjusting/selecting features used by the machine learning model(s). Various tuning configurations (e.g., different versions of the machine learning model and features) can be implemented while training in order to arrive at a configuration for machine learning model(s) that, when trained, achieves desired performance (e.g., performs predictions at a desired level of accuracy, run according to desired resource utilization/time metrics, and the like). Retraining and updating the training can include training with updated training data. For example, the training data can be updated to incorporate observed data, or data that has otherwise been labeled (e.g., for use with supervised learning).

Implementations can fine-tune large language model(s) with domain specific language data. For example, historical health data can be aggregated to generate a set of training data specific to healthcare. A pre-trained large language model can be fine-tuned with the set of training data to generate a large language model configured for health data. For example, one or more layers, nodes, weights, etc. of the pre-trained large language model can be updated and/or added via the fine-tuning to configure the large language model for health data. In some implementations, the fine-tuned large language model can be prompted to analyze health data and return results (e.g., data visualizations, tables of data, answers to queries, etc.).

In some examples, the healthcare software can automatically flag conditions and/or suggest changes to the user's care plan based on the data being generated related to the care plan. For example, natural language processing models can process the user's patient notes, and certain sentiment can be mapped to predefined recommendations, such as reducing the intensity of physical therapy when the patient's reported pain is high, recommending a patient consultation when the patient notes indicate confusion with the care plan, triggering an alert that schedules a patient consultation when monitored health metric(s) fail to meet a criteria, and the like.

Machine learning models and/or artificial intelligence can be implemented to process the user's health data and/or the data being generated related to a care plan to flag conditions and/or suggest changes. For example, monitored metric(s) can be processed by the model(s), patient notes can be processed by the model(s), data generated via a user visit to a hospital/doctor's office can be processed by the model(s), and any other suitable user health data can be processed by the model(s). The model(s), based on the processing, can generate recommended changes to the care plan and/or raise flags for care team review.

In connection with LLM 125, embodiments leverage semantic user interface actions which supports navigation and filtering across the application. The semantic user interface actions supports specific prompts and utterances such as “show me my current health insurance information”, to route to the information for the health insurance information on file, or “show me my latest health insurance claims”, which would route and filter specific information based on the prompt. The semantic user interface action prompts and utterances are built into the artificial intelligence manifest which can be leveraged by users based on the prompts and utterances added to the manifest which is also training with similar words and phrases so that LLM 125 understands the specific request by the user. The AI manifest is integrated across the application based on an AI agent that extends across the entire application and built into the core search bar and/or conversational search features.

In connection with generative AI models 126, the search bar and/or conversational search which supports the user's prompts and utterances can leverage simple queries through AI tasks, such as semantic user interface actions, and also supports generative AI models. Generative AI models 126 in embodiments are trained based on specific AI agent functions for specific actions that are trained to the model. Based on basic actions such as scheduling, rescheduling, or cancelling an appointment, the database is associated with the AI agent to derive related data. The database is connected to a healthcare provider's single tenant electronic health record system and has embedded identity authorization tokens which connects directly to a patient identifier to derive the respective patient's health and financial information. The patient identifier is tokenized and operates with an identity and access management permission which associates the patient identifier within the electronic health record with a patient's verified email address and mobile phone number.

Based on the specific actions (i.e., schedule, reschedule, cancel appointment) and patient's information associated with the patient identifiers, the generative AI 126 is able to infer the data and provide additional capability that uses the patient's information in association with specific health insurance information derived from APIs for the health insurance plans, pricing, associated covered benefits, and price transparency for a certain medical code (e.g., DRG, ICD-10, SNOWMED, etc.).

The generative AI models 126 are also able to derive a patient's previous health insurance benefit plans, coverage, deductible and copay, as well as previous healthcare utilization to generate a price forecast based on specific health utilization for each health insurance plan that is available (i.e., HMO, PPO, etc.). The average price of the plan, visits, specific procedures, medications, and available services covered in the health plan would also be exposed for the patient where they could access them through AI or the AI can generate the available service and cost estimates where the patient could download or share the information.

The generative AI model 126 would also understand certain health insurance plans a patient would qualify for based on their demographics, such as age, zip code location, financials, and other healthcare factors.

The generative AI model 126 can also interpret additional information from the APIs and information for certain health insurance and payer related programs such as CMS bundled payments, Medicare Shared Savings Program bundles, and wellness programs. The information for qualifying patients and programs are also available to the healthcare provider organization to associate patient registries to create health care plans and wellness programs for patients.

### Example Cloud Infrastructure

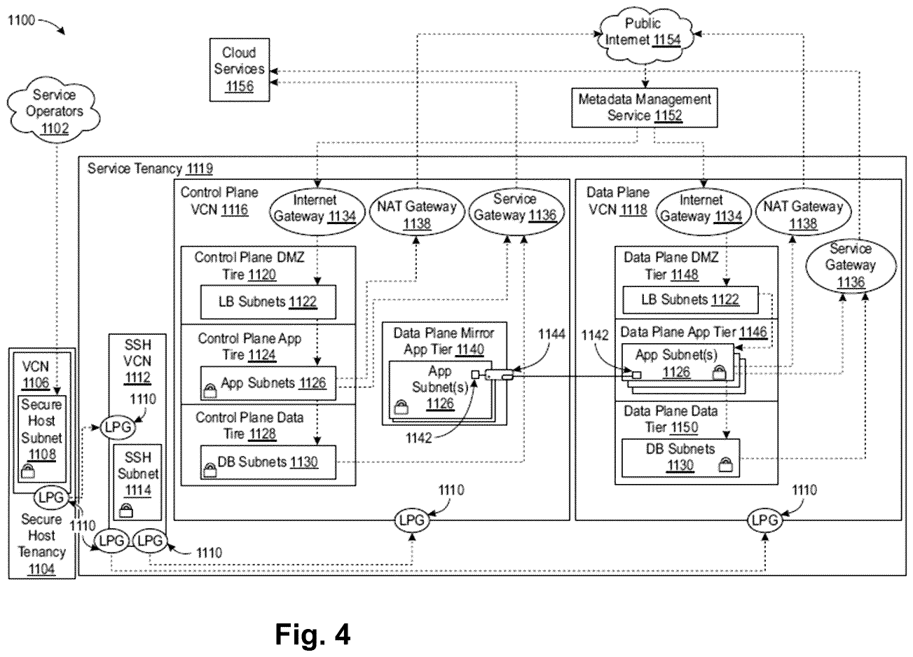

FIGS. 4-7 illustrate an example cloud infrastructure that can implement network cloud 104 that can include health insurance enrollment system 10 of FIG. 1 in accordance to embodiments.

As disclosed above, infrastructure as a service (“IaaS”) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (“WAN”), such as the Internet, and can use the cloud provider's services to install the remaining elements of an application stack. For example, the user can log in to the IaaS platform to create virtual machines (“VM” ), install operating systems (“OS” ) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (“VPC” ) (e.g., a potentially on-demand pool of configurable and/or shared computing resources), also known as a core network. In some examples, there may also be one or more security group rules provisioned to define how the security of the network will be set up and one or more virtual machines. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 4 is a block diagram 1100 illustrating an example pattern of an IaaS architecture, according to at least one embodiment. Service operators 1102 can be communicatively coupled to a secure host tenancy 1104 that can include a virtual cloud network (“VCN”) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (“PDA”)) or wearable devices (e.g., a Meta Quest® head mounted display), running software such as Microsoft Windows Mobile®, and/or a variety of mobile operating systems such as iOS, Windows Phone, Android, BlackBerry 8, Palm OS, and the like, and being Internet, e-mail, short message service (“SMS”), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (“LPG”) 1110 that can be communicatively coupled to a secure shell (“SSH”) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (“DMZ”) tier 1120 that acts as a perimeter network (e.g., portions of a corporate network between the corporate intranet and external networks). The DMZ-based servers may have restricted responsibilities and help keep security breaches contained. Additionally, the DMZ tier 1120 can include one or more load balancer (“LB”) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (“API”) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (“CRUD”) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Memory that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of security, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

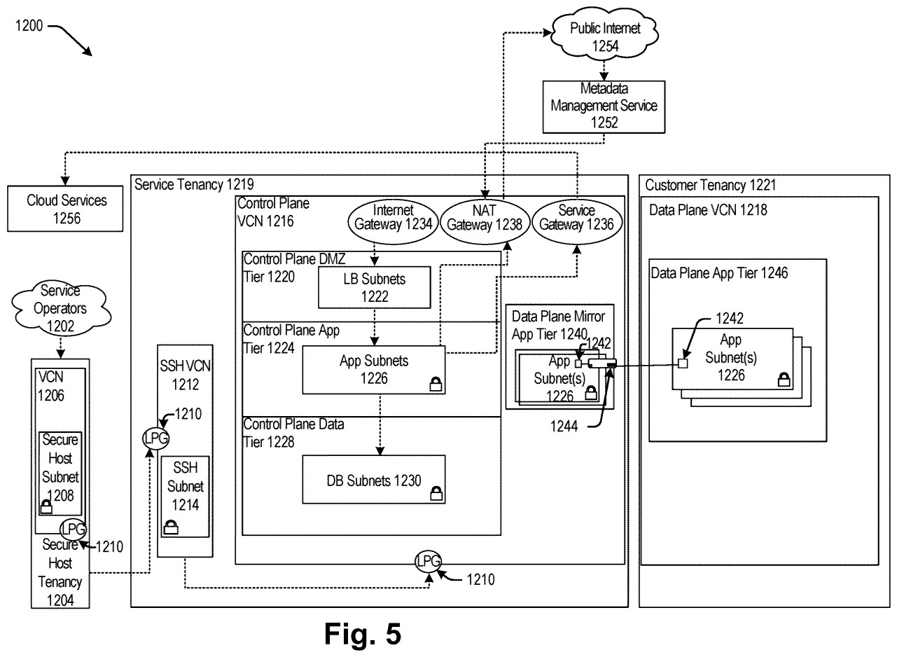

FIG. 5 is a block diagram 1200 illustrating another example pattern of an IaaS architecture, according to at least one embodiment. Service operators 1202 (e.g. service operators 1102) can be communicatively coupled to a secure host tenancy 1204 (e.g. the secure host tenancy 1104) that can include a virtual cloud network (VCN) 1206 (e.g. the VCN 1106) and a secure host subnet 1208 (e.g. the secure host subnet 1108). The VCN 1206 can include a local peering gateway (LPG) 1210 (e.g. the LPG 1110) that can be communicatively coupled to a secure shell (SSH) VCN 1212 (e.g. the SSH VCN 1112 10) via an LPG 1110 contained in the SSH VCN 1212. The SSH VCN 1212 can include an SSH subnet 1214 (e.g. the SSH subnet 1114), and the SSH VCN 1212 can be communicatively coupled to a control plane VCN 1216 (e.g. the control plane VCN 1116) via an LPG 1210 contained in the control plane VCN 1216. The control plane VCN 1216 can be contained in a service tenancy 1219 (e.g. the service tenancy 1119), and the data plane VCN 1218 (e.g. the data plane VCN 1118) can be contained in a customer tenancy 1221 that may be owned or operated by users, or customers, of the system.

The control plane VCN 1216 can include a control plane DMZ tier 1220 (e.g. the control plane DMZ tier 1120) that can include LB subnet(s) 1222 (e.g. LB subnet(s) 1122), a control plane app tier 1224 (e.g. the control plane app tier 1124) that can include app subnet(s) 1226 (e.g. app subnet(s) 1126), a control plane data tier 1228 (e.g. the control plane data tier 1128) that can include database (DB) subnet(s) 1230 (e.g. similar to DB subnet(s) 1130). The LB subnet(s) 1222 contained in the control plane DMZ tier 1220 can be communicatively coupled to the app subnet(s) 1226 contained in the control plane app tier 1224 and an Internet gateway 1234 (e.g. the Internet gateway 1134) that can be contained in the control plane VCN 1216, and the app subnet(s) 1226 can be communicatively coupled to the DB subnet(s) 1230 contained in the control plane data tier 1228 and a service gateway 1236 and a network address translation (NAT) gateway 1238 (e.g. the NAT gateway 1138). The control plane VCN 1216 can include the service gateway 1236 and the NAT gateway 1238.

The control plane VCN 1216 can include a data plane mirror app tier 1240 (e.g. the data plane mirror app tier 1140) that can include app subnet(s) 1226. The app subnet(s) 1226 contained in the data plane mirror app tier 1240 can include a virtual network interface controller (VNIC) 1242 (e.g. the VNIC of 1142) that can execute a compute instance 1244 (e.g. similar to the compute instance 1144). The compute instance 1244 can facilitate communication between the app subnet(s) 1226 of the data plane mirror app tier 1240 and the app subnet(s) 1226 that can be contained in a data plane app tier 1246 (e.g. the data plane app tier 1146) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g. the metadata management service 1152) that can be communicatively coupled to public Internet 1254 (e.g. public Internet 1154). Public Internet 1254 can be communicatively coupled to the NAT gateway 1238 contained in the control plane VCN 1216. The service gateway 1236 contained in the control plane VCN 1216 can be communicatively couple to cloud services 1256 (e.g. cloud services 1156).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218, but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 8,” may be located in Region 1 and in “Region 2.” If a call to Deployment 8 is made by the service gateway 1236 contained in the control plane VCN 1216 located in Region 1, the call may be transmitted to Deployment 8 in Region 1. In this example, the control plane VCN 1216, or Deployment 8 in Region 1, may not be communicatively coupled to, or otherwise in communication with, Deployment 8 in Region 2.

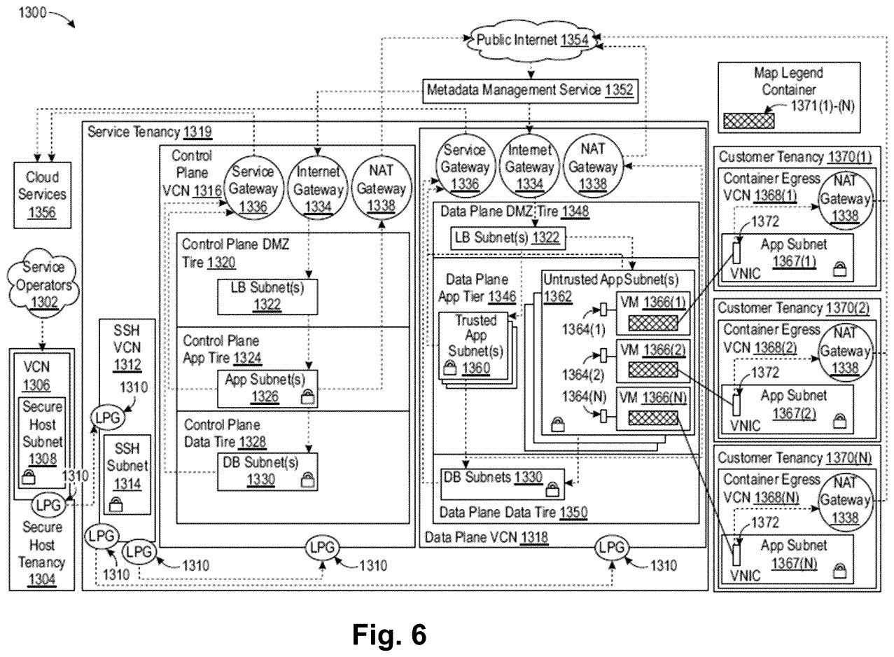

FIG. 6 is a block diagram 1300 illustrating another example pattern of an IaaS architecture, according to at least one embodiment. Service operators 1302 (e.g. service operators 1102) can be communicatively coupled to a secure host tenancy 1304 (e.g. the secure host tenancy 1104) that can include a virtual cloud network (VCN) 1306 (e.g. the VCN 1106) and a secure host subnet 1308 (e.g. the secure host subnet 1108). The VCN 1306 can include an LPG 1310 (e.g. the LPG 1110) that can be communicatively coupled to an SSH VCN 1312 (e.g. the SSH VCN 1112) via an LPG 1310 contained in the SSH VCN 1312. The SSH VCN 1312 can include an SSH subnet 1314 (e.g. the SSH subnet 1114), and the SSH VCN 1312 can be communicatively coupled to a control plane VCN 1316 (e.g. the control plane VCN 1116) via an LPG 1310 contained in the control plane VCN 1316 and to a data plane VCN 1318 (e.g. the data plane 1118) via an LPG 1310 contained in the data plane VCN 1318. The control plane VCN 1316 and the data plane VCN 1318 can be contained in a service tenancy 1319 (e.g. the service tenancy 1119).

The control plane VCN 1316 can include a control plane DMZ tier 1320 (e.g. the control plane DMZ tier 1120) that can include load balancer (“LB”) subnet(s) 1322 (e.g. LB subnet(s) 1122), a control plane app tier 1324 (e.g. the control plane app tier 1124) that can include app subnet(s) 1326 (e.g. similar to app subnet(s) 1126), a control plane data tier 1328 (e.g. the control plane data tier 1128) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g. the Internet gateway 1134) that can be contained in the control plane VCN 1316, and the app subnet(s) 1326 can be communicatively coupled to the DB subnet(s) 1330 contained in the control plane data tier 1328 and to a service gateway 1336 (e.g. the service gateway) and a network address translation (NAT) gateway 1338 (e.g. the NAT gateway 1138). The control plane VCN 1316 can include the service gateway 1336 and the NAT gateway 1338.

The data plane VCN 1318 can include a data plane app tier 1346 (e.g. the data plane app tier 1146), a data plane DMZ tier 1348 (e.g. the data plane DMZ tier 1148), and a data plane data tier 1350 (e.g. the data plane data tier 1150). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g. public Internet 1154).

The Internet gateway 1334 contained in the control plane VCN 1316 and contained in the data plane VCN 1318 can be communicatively coupled to a metadata management service 1352 (e.g., the metadata management system 1152) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively couple to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

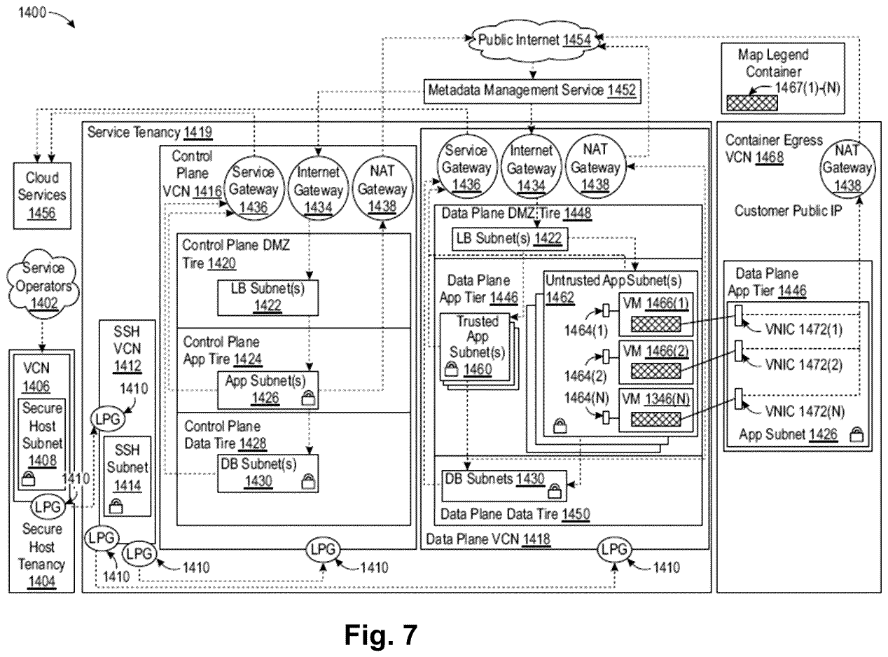

FIG. 7 is a block diagram 1400 illustrating another example pattern of an IaaS architecture, according to at least one embodiment. Service operators 1402 (e.g. service operators 1102) can be communicatively coupled to a secure host tenancy 1404 (e.g. the secure host tenancy 1104) that can include a virtual cloud network (“VCN”) 1406 (e.g. the VCN 1106) and a secure host subnet 1408 (e.g. the secure host subnet 1108). The VCN 1406 can include an LPG 1410 (e.g. the LPG 1110) that can be communicatively coupled to an SSH VCN 1412 (e.g. the SSH VCN 1112) via an LPG 1410 contained in the SSH VCN 1412. The SSH VCN 1412 can include an SSH subnet 1414 (e.g. the SSH subnet 1114), and the SSH VCN 1412 can be communicatively coupled to a control plane VCN 1416 (e.g. the control plane VCN 1116) via an LPG 1410 contained in the control plane VCN 1416 and to a data plane VCN 1418 (e.g. the data plane 1118) via an LPG 1410 contained in the data plane VCN 1418. The control plane VCN 1416 and the data plane VCN 1418 can be contained in a service tenancy 1419 (e.g. the service tenancy 1119).

The control plane VCN 1416 can include a control plane DMZ tier 1420 (e.g. the control plane DMZ tier 1120) that can include LB subnet(s) 1422 (e.g. LB subnet(s) 1122), a control plane app tier 1424 (e.g. the control plane app tier 1124) that can include app subnet(s) 1426 (e.g. app subnet(s) 1126), a control plane data tier 1428 (e.g. the control plane data tier 1128) that can include DB subnet(s) 1430 (e.g. DB subnet(s) 1330). The LB subnet(s) 1422 contained in the control plane DMZ tier 1420 can be communicatively coupled to the app subnet(s) 1426 contained in the control plane app tier 1424 and to an Internet gateway 1434 (e.g. the Internet gateway 1134) that can be contained in the control plane VCN 1416, and the app subnet(s) 1426 can be communicatively coupled to the DB subnet(s) 1430 contained in the control plane data tier 1428 and to a service gateway 1436 (e.g. the service gateway 1136) and a network address translation (NAT) gateway 1438 (e.g. the NAT gateway 1138). The control plane VCN 1416 can include the service gateway 1436 and the NAT gateway 1438.

The data plane VCN 1418 can include a data plane app tier 1446 (e.g. the data plane app tier 1146), a data plane DMZ tier 1448 (e.g. the data plane DMZ tier 1148), and a data plane data tier 1450 (e.g. the data plane data tier 1150). The data plane DMZ tier 1448 can include LB subnet(s) 1422 that can be communicatively coupled to trusted app subnet(s) 1460 (e.g. trusted app subnet(s) 1360) and untrusted app subnet(s) 1462 (e.g. untrusted app subnet(s) 1362) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g. public Internet 1154).

The Internet gateway 1434 contained in the control plane VCN 1416 and contained in the data plane VCN 1418 can be communicatively coupled to a metadata management service 1452 (e.g. the metadata management system 1152) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some examples, the pattern illustrated by the architecture of block diagram 1400 of FIG. 7 may be considered an exception to the pattern illustrated by the architecture of block diagram 1300 of FIG. 6 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate certain embodiments. In some other embodiments, the IaaS systems may have more or fewer components than shown in the figures, may combine two or more components, or may have a different configuration or arrangement of components.

As disclosed, embodiments provide an AI based solution to facilitate health insurance enrollment. Embodiments allow for a quicker process of enrollment for the patient and allow the patient an opportunity to better understand their choices for insurance coverage. Embodiments can alleviate any lapses in Medical coverage, saving the patient money. Embodiments can help reduce decision fatigue by simplifying complex information.

Other embodiments can consider a consumer's health history, provider preferences, prescription needs, and budget (when payer information is integrated into the portal). These deeper insights enhance the ability to accurately suggest the most appropriate plan for the consumer's unique needs because historically, the burden is on the consumer to investigate plans and explore their offerings versus have a tool that curates this information face-up for easy consumption.

CMS programs and marketplaces require insurers to provide consumers cost transparency and access to clear, comparable data. Embodiments allow customers to compare plans against one another versus having to manually collect that data and manually compare. Embodiments will increase consumer engagement as users are more likely to complete enrollment if they are confident in their decision making, reducing enrollment drop-off rates.

With embodiments, pre-filling the form with previously verified information not only expedites the workflow, but it also ensures better accuracy. Embodiments can lead to increase adequate insurance coverage of the population by helping users find and enroll in plans that better meet their needs with a better confidence and understanding of the costs and benefits.

With embodiments, telemetry data could be used to help employers and insurance plans better understand what factors are important to users when evaluating and selecting a plan. Embodiments provide a reduction in human support needed to explain and answer questions about plan options and details. Embodiments provide increased patient engagement in their healthcare and focus on wellness and preventive care.

Embodiments can be connected to the semantic index architecture where the electronic health record, patient administration system, patient accounting system, and patient portal are all connected on the same architecture and centralized database within a single tenant architecture for a healthcare provider. In association with the semantic index architecture, there are semantic objects which support data and services are also integrated within the semantic index architecture through API orchestration and additional custom data elements established within the semantic object model.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of providing cloud based health insurance enrollment for a user, the method comprising:
determining that open health insurance enrollment is available for the user;
using a pre-trained large language learning machine learning (ML) model, automatically presenting to the user a plurality of available health insurance options based on a current health insurance or qualifications for insurance;
using the ML model, automatically analyzing the available health insurance options; and
using a generative artificial intelligence (AI) model, automatically answering questions from the user regarding the available health insurance options.

2. The method of claim 1, further comprising:
using the ML model, automatically pre-filling user information on a selected health insurance form, the user information retrieved from a user portal profile.

3. The method of claim 1, wherein the automatically analyzing comprises generating a summary of each of the available health insurance options.

4. The method of claim 1, further comprising:
automatically generating an alert when open health insurance enrollment is available for the user.

5. The method of claim 1, further comprising:
automatically predicting out of pocket expenses for the user for each of the available health insurance options.

6. The method of claim 1, further comprising:
automatically predicting cost estimates of medications for each of the available health insurance options.

7. The method of claim 1, further comprising:
automatically identifying medical team members for the user and determine which of the medical team members are in-network for each of the available health insurance options.

8. The method of claim 1, further comprising:
automatically predicting when the user would meet a deductible for each of the available health insurance options.

9. A computer-readable medium storing instructions which, when executed by at least one of a plurality of processors, cause the processors to provide cloud based health insurance enrollment for a user, the providing comprising:
determining that open health insurance enrollment is available for the user;
using a pre-trained large language learning machine learning (ML) model, automatically presenting to the user a plurality of available health insurance options based on a current health insurance or qualifications for insurance;
using the ML model, automatically analyzing the available health insurance options; and
using a generative artificial intelligence (AI) model, automatically answering questions from the user regarding the available health insurance options.

10. The computer-readable medium of claim 9, the providing further comprising:
using the ML model, automatically pre-filling user information on a selected health insurance form, the user information retrieved from a user portal profile.

11. The computer-readable medium of claim 9, wherein the automatically analyzing comprises generating a summary of each of the available health insurance options.

12. The computer-readable medium of claim 9, the providing further comprising:
automatically generating an alert when open health insurance enrollment is available for the user.

13. The computer-readable medium of claim 9, the providing further comprising:
automatically predicting out of pocket expenses for the user for each of the available health insurance options.

14. The computer-readable medium of claim 9, the providing further comprising:
automatically predicting cost estimates of medications for each of the available health insurance options.

15. The computer-readable medium of claim 9, the providing further comprising:
automatically identifying medical team members for the user and determine which of the medical team members are in-network for each of the available health insurance options.

16. The computer-readable medium of claim 9, the providing further comprising:
automatically predicting when the user would meet a deductible for each of the available health insurance options.

17. A cloud based machine learning (ML) model training system for providing cloud based health insurance enrollment for a user comprising:
one or more machine learning (ML) models;
one or more processors executing instructions and coupled to the ML models, the processors adapted to use the ML models to:
determine that open health insurance enrollment is available for the user;
automatically presenting to the user a plurality of available health insurance options based on a current health insurance or qualifications for insurance;
automatically analyzing the available health insurance options; and
automatically answering questions from the user regarding the available health insurance options.

18. The system of claim 17, the processors further adapted to:
automatically pre-fill user information on a selected health insurance form, the user information retrieved from a user portal profile.

19. The system of claim 17, wherein the automatically analyzing comprises generating a summary of each of the available health insurance options.

20. The system of claim 17, wherein the system is executed on a cloud infrastructure, the cloud infrastructure comprising a first virtual cloud network (VCN) comprising a local peering gateway (LPG) communicatively coupled to a secure shell (SSH) VCN via the LPG;
wherein the LPG is contained in a control plane VCN and the SSH VCN is communicatively coupled to a data plane VCN.
